(19) United States
(12) Patent Application Publication
(10) Pub. No.: US 2012/0241634 A1
(43) Pub. Date: Sep. 27, 2012

(54) IMAGE PICKUP APPARATUS, IMAGE PICKUP SYSTEM, AND METHOD OF CONTROLLING THEM

(75) Inventors: Toshio Kameshima, Kumagaya-shi (JP); Tomoyuki Yagi, Honjo-shi (JP); Katsuro Takenaka, Honjo-shi (JP); Sho Sato, Kumagaya-shi (JP); Atsushi Iwashita, Honjo-shi (JP)

(73) Assignee: CANON KABUSHIKI KAISHA, Tokyo (JP)

(21) Appl. No.: 13/422,930

(22) Filed: Mar. 16, 2012

(30) Foreign Application Priority Data
Mar. 24, 2011 (JP) 2011-065981

(51) Int. Cl. H01L 27/146; G01T 1/24

(52) U.S. Cl. 250/370.08; 250/208.1; 250/371

(57) ABSTRACT

In an image pickup apparatus, a detector includes a detection unit and a driving circuit; the detection unit including a plurality of pixels each including a conversion element having a semiconductor layer, and the driving circuit being configured to drive the detection unit whereby the detector performs an image pickup operation to output the electric signal. A power supply unit supplies a voltage to the conversion element. A control unit controls the power supply unit such that the voltage applied to the semiconductor layer is higher in at least part of a period from the start of supplying the voltage to the semiconductor layer from the power supply unit to the start of the image pickup operation than in the image pickup operation.

### BACKGROUND OF THE INVENTION

1. Field of the Invention

The present invention relates to an image pickup apparatus, an image pickup system, and a method of controlling the image pickup apparatus and the image pickup system. More particularly, the present invention relates to a radiation image pickup apparatus and a radiation image pickup system, and a method of controlling the apparatus or system. The apparatus, system or method may be suitable for use in capturing a general still image or a moving image in fluoroscopy.

2. Description of the Related Art

In recent years, a radiation image pickup apparatus using a flat panel detector (hereinafter referred to as a detector) produced using a semiconductor material has been used in practical applications such as medical diagnosis nondestructive inspection, or the like. One of such radiation image pickup apparatuses is a digital image pickup apparatus used to capture a general still image or a fluoroscopic moving image based on X-ray radiation, for use in medical diagnosis. As for the detector, it is known to use an indirect-conversion detector using a conversion element realized by combining a photoelectric conversion element using amorphous silicon and a wavelength conversion element for converting radiation into light of a wavelength detectable by the photoelectric conversion element. A direct-conversion detector is also known which uses a conversion element formed using amorphous selenium or a similar material capable of directly converting radiation into an electric charge.

In image pickup apparatuses of the types described above, the amorphous semiconductor forming the conversion element may include dangling bonds or defects functioning as trap levels. Such dangling bonds or defect may cause a change in dark current. When there are dangling bonds, illumination of radiation or light performed in the past may cause an afterimage (lag) to be generated and the dangling bond may cause a change of the afterimage to occur. As a result, a change can occur in a characteristic of the image pickup apparatus or in an image signal acquired by the image pickup apparatus. U.S. Patent Application Publication No. 2008/0226031 discloses a technique to, before exposing a detector to radiation or light bearing object information, expose the detector with light bearing no object information emitted from a dedicated light source to thereby suppress a change in characteristic of the image pickup apparatus or a change in an acquired image signal.

However, in the method disclosed in U.S. Patent Application Publication No. 2008/0226031 it is necessary to dispose the dedicated light source and a driving unit for driving the light source in the apparatus. Furthermore, to suppress a change in characteristic of the detector equally across the detector or equally suppress a change in an image signal, it is necessary to illuminate the detector with the light emitted from the light source such that the detector is illuminated uniformly over the whole surface thereof. However, to achieve uniform illumination with light emitted from the light source, it is necessary to provide a power supply to supply a high operating voltage and/or the light source needs a complicated structure. As a result, the light source and/or a driving unit thereof have a large size, which makes it difficult to realize the image pickup apparatus with a small size and a small weight. Besides, degradation in characteristic of the light source may occur, which makes it difficult or complicated to control the light source to achieve good uniformity of luminance across the whole surface of the detector. Thus, it becomes difficult to easily control the operation of the image pickup apparatus.

### SUMMARY OF THE INVENTION

In view of the above, an embodiment of the present invention provides a small-sized, light-weight, and easy-to-control image pickup apparatus and an image pickup system using such an image pickup apparatus capable of capturing a high-quality image while suppressing a change in characteristics of the image pickup apparatus. According to an aspect of the invention, there is provided an image pickup apparatus including a detector including a detection unit and a drive circuit, the detection unit including a plurality of conversion elements each including a semiconductor layer configured to convert radiation or light into an electric charge, and the driving circuit configured to drive the detection unit to output an electric signal corresponding to the electric charge from the detection unit, whereby the detector performs an image pickup operation to output the electric signal. The image pickup apparatus further includes a control unit configured to control the power supply unit such that the voltage applied to the semiconductor layer during at least part of a period prior to a start of the image pickup operation is higher than the voltage applied to the semiconductor layer in the image pickup operation.

In another aspect of the invention, there is provided an image pickup system including the image pickup apparatus described above, and a control computer that transmits a control signal to the control unit.

In another aspect of the invention, there is provided a method of controlling an image pickup apparatus including a detection unit including a plurality of conversion elements each including a semiconductor layer configured to convert radiation or light into an electric charge, and a driving circuit configured to drive the detection unit to output an electric signal corresponding to the electric charge from the detection unit, whereby the detector performs an image pickup operation to output the electric signal, the method including performing the image pickup operation to output the electric signal, and applying a voltage to the semiconductor layer such that the voltage is higher during at least a part of a period prior to a start of the image pickup operation than in the image pickup operation.

Thus, it is possible to provide a small-sized, light-weight, and easy-to-control image pickup apparatus capable of capturing a high-quality image while suppressing a change in characteristic of the image pickup apparatus or a change in an image signal acquired by the image pickup apparatus. It is also possible provide an image pickup system using such an image pickup apparatus.

Further features of the present invention will become apparent from the following description of exemplary embodiments with reference to the attached drawings.

### BRIEF DESCRIPTION OF THE DRAWINGS

FIG. 1 is a block diagram schematically illustrating an image pickup system according to an embodiment of the present invention.

FIG. 2 is a simplified equivalent circuit diagram of an image pickup apparatus according to the first embodiment of the present invention.

FIG. 3A is a characteristic diagram illustrating time dependence of a dark current of a conversion element according to the first embodiment of the present invention, and FIG. 3B is a characteristic diagram illustrating time dependence of an amount of afterimage of the conversion element according to the first embodiment of the present invention.

FIGS. 4A to 4C are timing charts associated with an image pickup apparatus according to the first embodiment of the present invention.

FIG. 5 is a flow chart illustrating an operation performed by an image pickup system according to a first embodiment of the present invention.

FIG. 6A is a simplified equivalent circuit diagram of an image pickup apparatus according to a modification to the first embodiment of the present invention, and FIG. 6B is a timing chart associated with an image pickup apparatus according to the modification to the first embodiment of the present invention.

FIGS. 7A and 7B are equivalent circuit diagrams of an image pickup apparatus according to a second embodiment of the present invention.

FIG. 8 is a characteristic diagram illustrating time dependence of afterimage of a conversion element according to the second embodiment of the present invention.

FIGS. 9A to 9C are timing charts associated with the image pickup apparatus according to the second embodiment of the present invention.

### DESCRIPTION OF THE EMBODIMENTS

The present invention is described in detail below with reference to embodiments in conjunction with the accompanying drawings. In the present description, the term “radiation” is used to describe a wide variety of radiant rays including various beams of particles (note that a photon is one of such particles) emitted via radioactive decay such as an alpha beam, a beta beam, and a gamma ray, and other beams with high energy similar to that of such particle beams. For example, an X-ray, a cosmic ray, etc., fall in the scope of radiations.

### First Embodiment

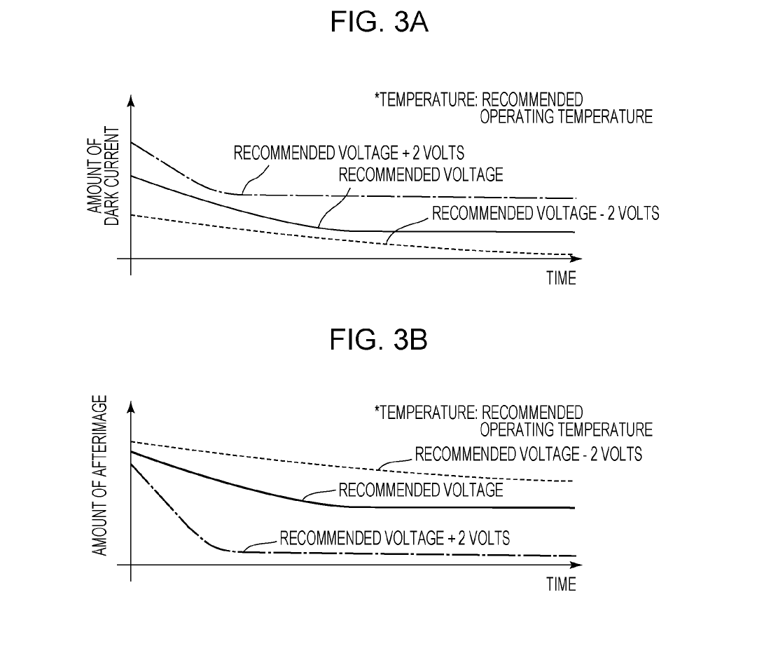

To explain the concept of the present invention, characteristics of a conversion element according to a first embodiment of the present invention are described below. More specifically, a characteristic in terms of a dark current is described referring to FIG. 3A, and a characteristic in terms of an afterimage is described referring to FIG. 3B. In FIGS. 3A and 3B, each horizontal axis indicates an elapsed time since the start of supplying a voltage to the conversion element. Note that in FIGS. 3A and 3B the supplying of the voltage starts at a leftmost point on each horizontal axis. In FIGS. 3A and 3B, a recommended voltage is a recommended value of the voltage supplied to the conversion element, and a recommended operating temperature is a recommended value of temperature of the conversion element during the image pickup operation.

The amount of afterimage is one of indices indicating the quality of the electric signal output from the detection unit and the quality of the image data produced based on the electric signal. An afterimage occurs in an image pickup operation performed following a previous image pickup operation even in a state in which no radiation or light is irradiated, as a result of an influence of an electric signal based on irradiation of radiation or light in a previous image pickup operation on an electric signal or image data output in a following image pickup operation. In the case of the PIN-type photodiode used as the conversion element in the present embodiment, main factors that cause the afterimage are an electric signal remaining without being completely output because of a large time constant associated with the switch element, kTC noise or partition noise generated when the signal is output by the switch element, etc.

Investigation performed by the present inventors has indicated that afterimages change with time since a voltage is supplied to the conversion element, and the change in amount of afterimage depends on the voltage applied to a semiconductor layer of the conversion element. As shown in FIG. 3A, a dark current appears immediately after the voltage is applied to the conversion element, and the magnitude thereof is the greatest immediately after the application of the voltage to the conversion element, and it decreases with elapsed time toward a particular convergence value. The dark current increases with increasing voltage applied to the semiconductor layer of the conversion element.

As for t afterimages, as shown in FIG. 3B, an afterimage appears immediately after the voltage is applied to the conversion element, and the magnitude thereof is the greatest immediately after the application of the voltage to the conversion element, and the amount of afterimage decreases with elapsed time toward a particular convergence value. As the voltage applied to the semiconductor layer of the conversion element is increased, the amount of afterimage decreases and the time needed for the amount of afterimage to converge the particular value decreases. This is because as the voltage increases, the dark current increases, and the increase in dark current results in an increase in the number of carriers trapped by crystal defects of the conversion element. As a result, the crystal defects are filled with charges in a shorter time, and the voltage applied to the conversion element converges to a stable state in a shorter time. Thus, the amount of afterimage goes in a stable state in a shorter time. Hereinafter, this stable state of the amount of afterimage will be referred to simply as the stable state.

In view of the above, in an aspect of the present invention, the voltage applied to the conversion element of the detection unit from the power supply unit during a period from the start of supplying the voltage to the conversion element to the start of the image pickup operation is set to be higher than in the image pickup operation. More specifically, the voltage applied to the semiconductor layer of the conversion element during the period from the start of supplying the voltage to the conversion element to the start of the image pickup operation is set to be higher than the voltage applied to the semiconductor layer of the conversion element in the image pickup operation. The voltage applied to the semiconductor layer refers to a potential difference between two ends of the semiconductor layer of the conversion element. More specifically, in the case of the PIN-type photodiode according to the present embodiment, the voltage refers to a potential difference between two electrodes of the conversion element, and the voltage is applied reversely. This results in a reduction in a time needed for the conversion element to come into a stable state after the supplying of the voltage to the conversion element is started, which makes it possible to reduce the period of the preparatory operation for image pickup operation performed in a period from the start of supplying the voltage to the start of the image pickup operation. The details of the image pickup operation and the preparatory operation for image pickup operation will be described later. At least in a part of the preparatory operation for image pickup operation period, the voltage supplied to the semiconductor layer from the power supply unit is set to be higher by 2 to 5 volts than a recommended operating voltage. The recommended operating voltage refers to a voltage with a recommended value for being applied to the conversion element (the semiconductor layer thereof) such that the detector has a good sensitivity and is capable of outputting a signal with a high signal-to-noise ratio. The supplying of the recommended operating voltage in the above-described manner makes it possible to achieve similar effects to those achieved by the technique using the light source, and the effects can be achieved with less power consumption. Furthermore, the controlling of the voltage by the power supply unit is easier than the controlling of the uniformity of light intensity across the surface of the detector in the technique using the light source. For similar reasons, it is possible to realize the apparatus in a smaller-size and smaller-weight structure than is possible in the technique using the light source and the driving unit thereof. Thus it is possible to provide a small-size and small-weight image pickup apparatus capable of capturing a high-quality image while suppressing a change in characteristics of the image pickup apparatus and it is also possible to provide an image pickup system using such an image pickup apparatus.

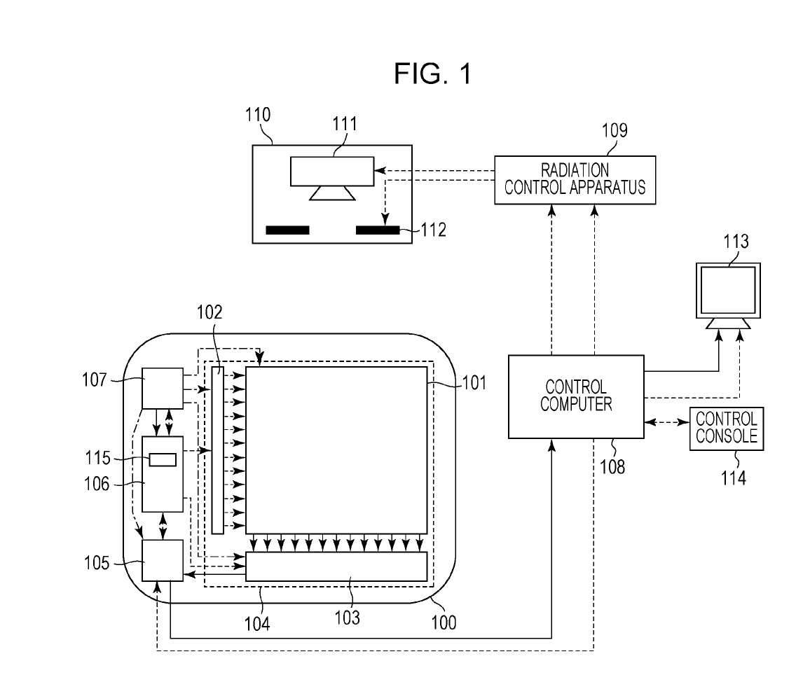

Next, referring to FIG. 1, a radiation image pickup system according to the first embodiment is described below. As shown in FIG. 1, the radiation image pickup system according to the present embodiment includes an image pickup apparatus 100, a control computer 108, a radiation control apparatus 109, a radiation generating apparatus 110, a display apparatus 113, and a control console 114. The image pickup apparatus 100 includes flat panel detector 104 including a detection unit 101 including a plurality of pixels each configured to convert radiation or light into an electric signal, a driving circuit 102 that drives the detection unit 101, and a reading circuit 103 that reads the electric signal from the driven detection unit 101 and outputs the electric signal as image data. The image pickup apparatus 100 further includes a signal processing unit 105 that processes the image data supplied from a flat panel detector (hereinafter, referred to simply as the detector) 104 and outputs the resultant image data, a control unit 106 that controls the operation of the detector 104 by supplying control signals to various elements, and a power supply unit 107 that supplies bias voltages to various elements. The signal processing unit 105 receives a control signal from a control computer 108 (described below) and supplies the control signal to the control unit 106. According to the control signal received from the control computer 108, the control unit 106 controls at least one of the driving circuit 102, the reading circuit 103, the signal processing unit 105, and the power supply unit 107. The power supply unit 107 includes power supply circuit such as a regulator that receives a voltage from an external power supply or an internal battery (not shown) and supplies necessary voltages to the detection unit 101, the driving circuit 102, and the reading circuit 103. In the present embodiment, the power supply unit 107 is capable of switching the potential applied to the pixels of the detection unit 101 among at least two or more values whereby the voltage supplied to the semiconductor layer of the conversion element is set to be higher at least in a part of the period prior to the start of the image pickup operation than the voltage supplied in the image pickup operation.

The control computer 108 transmits control signals to the radiation generating apparatus 110 and the image pickup apparatus 100 to synchronize them or determine the state of the image pickup apparatus 100, and performs image processing on the image data output from the image pickup apparatus 100 to perform a correction, storing, and displaying. The control computer 108 also transmits a control signal to the radiation control apparatus 109 to determine a radiation exposure condition based on the information supplied from the control console 114. According to the information given via the control console 114, the control computer 108 acquires the image pickup operation start time defined by the time elapsed since the start of the supplying of the voltage from the power supply unit 107 to the detection unit 101 until the start of the image pickup operation. Based on the acquired image pickup operation start time, the control computer 108 supplies a control signal to the control unit 106 and transmits the information indicating the image pickup operation start time to a calculation unit 117 (described below).

According to the control signal received from the control computer 108, the radiation control apparatus 109 controls the operation of emitting radiation from a radiation source 111 disposed in the radiation generating apparatus 110 and controls the operation of an exposure field limiting mechanism 112. The exposure field limiting mechanism 112 has a function of changing the exposure field size which is an area, irradiated with radiation or light corresponding to radiation, of the detection unit 101 of the detector 104. When parameters in terms of object information, image pickup conditions, etc., used by the control computer 108 in its control operation are input via the control console 114, the input parameters are transmitted to the control computer 108. The display apparatus 113 displays an image according to the image data processed by the control computer 108. The storage unit 115 is disposed in the control unit 106 and holds prestored information in terms of the voltage applied to the conversion element or the voltage applied to the semiconductor layer of the conversion element and a stabilization completion time. Although in the present embodiment the storage unit is disposed in the control unit 106, the storage unit may be alternatively disposed in the control computer 108. This is not limited to the present embodiment but may be applied to other embodiments of the present invention.

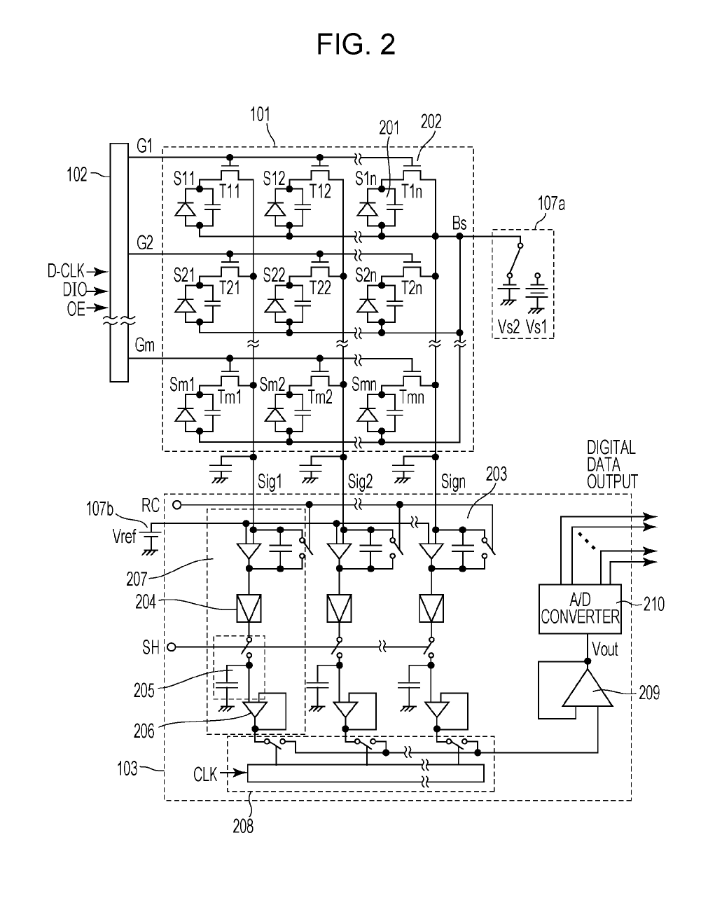

Next, referring to FIG. 2, an image pickup apparatus according to the first embodiment of the present invention is described below. In FIG. 2, similar elements to those shown in FIG. 1 are denoted by similar reference symbols or numerals, and a further detailed description thereof is omitted. The image pickup apparatus has a detector including pixels arranged in an array (matrix) with m rows and n columns, where m and n are integers equal to or greater than 2. In practical image pickup apparatuses, the detector includes a large number of pixels. However, FIG. 2 shows only 3 rows and 3 columns for simplicity of illustration. For example, in the case of a 17-inch image pickup apparatus, the detector typically includes pixels in an array with 2800 rows and 2800 columns.

In FIG. 2, the detection unit 101 includes a plurality of pixels arranged in an array including rows and columns. Each pixel includes a conversion element 201 that converts radiation or light into an electric charge and a switch element 202 that outputs an electric signal corresponding to the electric charge. In the present embodiment, a PIN-type photodiode formed using amorphous silicon as a main material on an insulating substrate such as a glass substrate is employed as the photoelectric conversion element for converting light incident on the conversion element into the electric charge. As for the conversion element, an indirect-conversion element may be used which includes a wavelength conversion element disposed on a radiation-incident side of the photoelectric conversion element described above such that the wavelength conversion element converts the incident radiation into light with a wavelength in a range that can be sensed by the photoelectric conversion element. Alternatively, a direct-conversion element capable of directly converting radiation into an electric charge may be used. As for the switch element 202, a transistor having a control terminal and two main terminals may be used. In the present embodiment, a thin film transistor (TFT) is employed as the switch element 202. One electrode of the conversion element 201 is electrically connected to one of the two main terminals of the switch element 202, and the other electrode of the conversion element 201 is electrically connected to the bias power supply 107a via a common bias supply line Bs. Plural n switch elements arranged in a particular row are electrically connected such that the control terminal of each switch element is electrically connected in common to a driving line in the particular row. For example, switch elements T11 to Tin in the first row are electrically connected such that the control terminal of each of these switch elements is connected in common to a driving line G1 in the first row. Via such driving lines, a driving signal for controlling turning-on/off of the switch elements is applied from a driving circuit 102 to the switch elements on a row-by-row basis. By controlling the turning-on/off of the switch elements 202 on the row-by-row basis, the driving circuit 102 scans the pixels on a row-by-row basis. Similarly, plural m switch elements arranged in a particular column are electrically connected such that the other main terminal of each of these switch elements is connected to a signal line in the particular column. More particularly, for example, the other main terminal of each of the switch elements T11 to Tm1 in a first column is electrically connected to a signal line Sig1 in the first column, whereby electric signals corresponding to electric charges of conversion elements are output to the reading circuit 103 via signal lines when the switch elements are in the on-state. That is, a plurality of signal lines Sig1 to Sign extending in the column direction transmit the electric signals output from the pixels in parallel to the reading circuit 103.

The reading circuit 103 includes amplifiers 207 disposed for the respective signal lines to thereby amplify the electric signals output in parallel from the detection unit 101. Each amplifier 207 includes an integrating amplifier 203 that amplifies the electric signal input thereto, a variable gain amplifier 204 that amplifies an electric signal output from the integrating amplifier 203, a sample-and-hold circuit 205 that samples and holds the amplified electric signal, and a buffer amplifier 206. The integrating amplifier 203 includes an operational amplifier that amplifies the read electric signal and outputs the resultant amplified electric signal, an integrating capacitor, and a reset switch. The integrating amplifier 203 includes has a gain that can be changed by changing the integrating capacitor. An inverting input terminal of the operational amplifier is applied with the output electric signal, a non-inverting input terminal thereof is applied with a reference voltage Vref supplied by a reference power supply 107b, and the amplified electric signal is output from an output terminal thereof. The integrating capacitor is disposed between the inverting input terminal and the output terminal of the operational amplifier. The sample-and-hold circuits 205 are disposed such that one sample-and-hold circuit 205 is provided for each amplifier. Each sample-and-hold circuit 205 includes a sampling switch and a sampling capacitor. The reading circuit 103 includes a multiplexer 208 and a buffer amplifier 209. The multiplexer 208 converts the electric signals output in parallel from the amplifiers 207 into a serial image signal. The buffer amplifier 209 performs an impedance conversion on the image signal and outputs the resultant image signal. The image signal Vout output in the form of an analog electric signal from the buffer amplifier 209 is converted by an analog-to-digital converter 210 into digital image data and supplied to the signal processing unit 105 shown in FIG. 1. The image data is processed by the signal processing unit 105 shown in FIG. 1 and the resultant image data is supplied to the control computer 108.

In accordance with control signals (D-CLK, OE, and DIO) given by the control unit 106 shown in FIG. 1, the driving circuit 102 outputs, to the respective driving lines, driving signals having either an on-voltage Vcom that causes the switch element to turn on or an off-voltage Vss that causes the switch element to turn off thereby to control the turning-on/off of the switch elements and thus drive the detection unit 101.

The power supply unit 107 shown in FIG. 1 includes the bias power supply 107a and the amplifier reference power supply 107b shown in FIG. 3. The bias power supply 107a supplies the voltage Vs1 or Vs2 in common to the other electrode of each conversion element via the bias supply line B. Vs1 and Vs2 are different values selectable for the voltage. The reference power supply 107b supplies the reference voltage Vref to the non-inverting input terminal of each operational amplifier. In the present embodiment, the reference voltage Vref is supplied to one of electrodes of each conversion element via a switch element, and the voltage Vs1 or Vs2 is supplied to the other electrode of the conversion element thereby to control the voltage applied to the semiconductor layer of the conversion element. In the present embodiment, Vs2 is the recommended operating voltage, and the following condition holds.

|Vs1−Vref|>|Vs2−Vref|

In FIG. 1, if the control unit 106 receives a control signal from the control computer 108 or the like disposed outside the apparatus via the signal processing unit 105, the control unit 106 supplies control signals to the driving circuit 102, the power supply unit 107, and the reading circuit 103 thereby to control the operations thereof. More specifically, the control unit 106 controls the operation of the driving circuit 102 by giving the control signal D-CLK, the control signal OE, and the control signal DIO to the driving circuit 102, where the control signal D-CLK is a shift clock of a shift register used as a driving circuit, the control signal DIO is a pulse transferred by the shift register, and the control signal OE is a signal for controlling the output terminal of the shift register. On the other hand, the control unit 106 controls various parts in the reading circuit 103 by supplying a control signal RC, a control signal SH, and a control signal CLK to the reading circuit 103 where the control signal RC controls the operation of the reset switch of the integrating amplifier, the control signal SH controls the operation of the sample-and-hold circuit 205, and the control signal CLK controls the operation of the multiplexer 208.

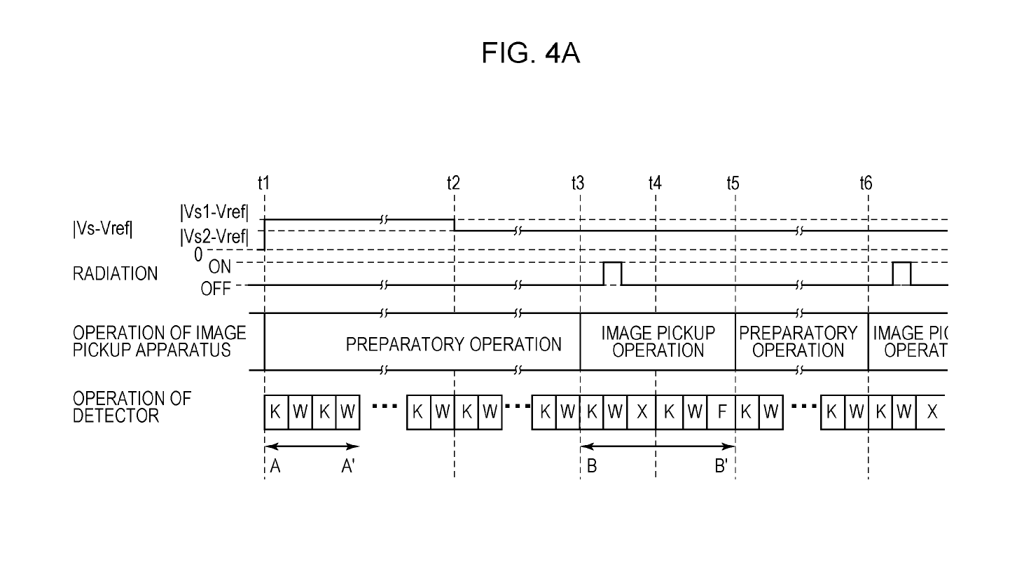

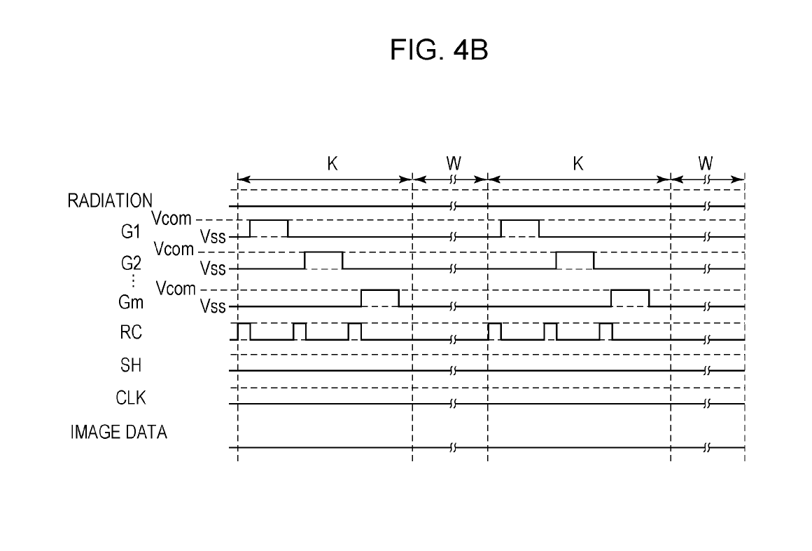

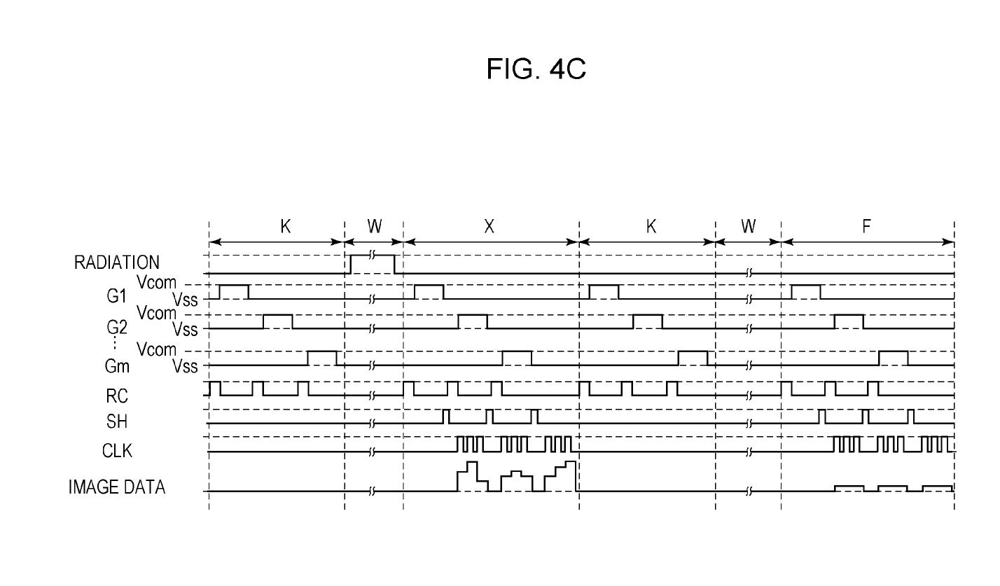

Next, referring to FIGS. 4A to 4C, the operation of the image pickup apparatus according to the present embodiment is described below. FIG. 4A illustrates general driving timing of the image pickup apparatus, FIG. 4B illustrates details of an interval from A to A′ in FIG. 4A, and FIG. 4C illustrates details of an interval from B to B′ in FIG. 4A.

In FIG. 4A and FIG. 4B, if the voltage |Vs1−Vref| or |Vs2−Vref| is supplied to the conversion element 201 at time t1, the image pickup apparatus 100 performs the preparatory operation for image pickup operation in an image pickup preparation period. The preparatory operation for image pickup operation refers to an operation of performing initialization process K at least once to stabilize a change in characteristic of the detector 104 that occur when the application of the voltage Vs is started. In the present embodiment, the initialization process K is performed repeatedly k times. The initialization process K is a process of applying an initial voltage |Vs1−Vref| or |Vs2−Vref| to the conversion element before the accumulation operation thereby to initialize the conversion element. In the flow chart shown in FIG. 4A, the preparatory operation for image pickup operation includes a plurality of sets each including the initialization K and the accumulation operation W, and the set of these operations is performed a plurality of times. In the present embodiment, in a period from time t1 to time t2, the voltage |Vs1−Vref| is applied to the conversion element 201, and the image pickup apparatus 100 performs the preparatory operation for image pickup operation. By performing the preparatory operation for image pickup operation in this period, the characteristic of the conversion element is stabilized. If the change in the characteristic of the conversion element has been stabilized, then in a period from time t2 to t3, the voltage |Vs2−Vref| is applied to the conversion element 201 and the image pickup apparatus 100 performs the preparatory operation for image pickup operation. When the change in characteristic of the detector 104 converges at time t2, in the state in which the voltage |Vs2−Vref| is applied to the conversion element 201, the image pickup apparatus 100 starts the image pickup operation. In a period from time t3 to t4 included in period from time t3 to t5, the image pickup apparatus 100 performs initialization K, the accumulation operation W, and an image output operation X. The accumulation operation W is an operation performed by the conversion element to generate an electric charge over a period corresponding to irradiation of radiation. The image output operation X is an operation of outputting image data based on an electric signal corresponding to the electric charge generated in the accumulation operation W. In the present embodiment, the accumulation operation W in the image pickup operation is performed during the period with the same length as the accumulation operation W in the preparatory operation for image pickup operation. However, the present invention does not have a particular restriction on the length of the accumulation operation W. To reduce the period of the preparatory operation for image pickup operation, the period of the accumulation operation W in the preparatory operation for image pickup operation may be set to be shorter than the accumulation operation W in the image pickup operation. In the present embodiment, to generate an electric charge by the conversion element in a dark state without irradiating radiation, a dark image output operation F is performed. In the dark image output operation F, an accumulation operation W is performed for a period with the same length as the accumulation operation W performed before the image output operation X, and dark image data is output based on the electric charge generated in the accumulation operation W. In the dark image output operation F, an operation similar to the image output operation X is performed by the image pickup apparatus 100. The dark image data obtained in the dark image output operation F is for use in determining difference data with respect to the image data obtained in the image output operation X. If the image pickup operation is complete at time t5, then the image pickup apparatus 100 starts another preparatory operation for image pickup operation in a mode in which the |Vs2−Vref| is applied to the conversion element and continues this preparatory operation for image pickup operation until time t6 at which the next image pickup operation is to be started.

Next, referring to FIG. 4B, the preparatory operation for image pickup operation is described in further detail below. In the initialization K, as shown in FIG. 4B, the control unit 106 first supplies the control signal RC to the reset switch to reset the integrating capacitor of the integrating amplifier 203 and the signal line. Next, in the state in which the voltage Vs is applied to the conversion element 201, the driving circuit 102 supplies the on-voltage Vcom to the driving line G1 to turn on the switch elements T11 to T13 of pixels in the first row. As a result of the turning-on of the switch elements, the conversion elements are initialized. In the initialization process, electric charges of conversion elements are output via the switch elements. However, in the present embodiment, the control signal SH and the control signal CLK are not output and thus the sample-and-hold circuit and circuit elements following it does not operate. Therefore, the reading circuit 103 does not output data corresponding to the above electric signal. Thereafter, the control signal RC is again output from the control unit 106, and the integrating capacitor and the signal line are reset again thereby to process the output electric signal. However, in a case where a correction or the like is performed using the data corresponding to the electric signal, the control signal SH and the control signal CLK may be output to operate the sample-and-hold circuit and circuit elements following it as in the image output operation or the dark image output operation. By performing the above-described operation including the turning-on of the switch elements and resetting repeatedly for the respective rows from the first to the m-th row, the detector 101 is initialized. In the initialization, the reset switch may be kept in the on-state also at least during the period in which the switch elements are in the on-state thereby to continue the resetting. The on-period of the switch element in the initialization may be shorter than the on-period of the switch element in the image output operation. In the initialization, the turning-on of the switch elements may be performed simultaneously for a plurality of rows. In either case, it becomes possible to reduce the total time of the initialization thereby allowing the change in characteristic of the detector to converge in a shorter time. Note that in the present embodiment, the initialization K is performed, after the preparatory operation for image pickup operation, in the same period in which the image output operation in the image pickup operation is performed. In the accumulation operation W, in the state in which the voltage Vs is applied to the conversion element 201, the off-voltage Vss is applied to the switch element 202 such that the switch element is in the off-state for all pixels.

Next, referring to FIG. 4C, the image pickup operation is described in further detail below. A further description of similar parts in the operation to those described above is omitted. In the image output operation, as shown in FIG. 4C, the control unit 106 first outputs the control signal RC to reset the integrating capacitor and the signal line. The on-voltage Vcom is then supplied to the driving line G1 from the driving circuit 102 to turn on the switch elements T11 to Tin in the first row. As a result, electric signals based on electric charges generated by conversion elements S11 to S1n in the first row are output to the respective corresponding signal lines Sig1 to Sign. The electric signals output in parallel via the signal lines Sig1 to Sign are amplified by the integrating amplifiers 203 and the variable gain amplifier 204 of the respective amplifiers 207. The amplified electric signals are held in parallel by the sample-and-hold circuits 205 that operate in response to the control signal SH. After the electric signals are held, the control signal RC is output from the control unit 106 to reset the integrating capacitor of the integrating amplifier 203 and the signal line. After the resetting, the on-voltage Vcom is applied to the driving line G2 in the second row as in the first row thereby to turn on the switch elements T21 to T2n in the second row. In the period in which the switch elements T21 to T2n in the second row are in the on-state, in response to the control signal CLK, the multiplexer 208 sequentially outputs the electric signals held by the sample-and-hold circuits 205. Thus, the electric signals read in parallel from the pixels in the first row are converted into a serial image signal, and the serial image signal is converted by the analog-to-digital converter 210 into one row of image data and output. The operation described above is performed for each row from the first row to the n-th row whereby one frame of image data is output from the image pickup apparatus. On the other hand, in the dark image output operation F, the image pickup apparatus 100 performs an operation in a similar manner to the image output operation X except that the operation is performed in a dark state in which no radiation is irradiated.

In the present embodiment, if the supplying of the voltage Vs to the conversion element 201 is started at time t1, the control unit 106 controls the power supply unit 107 to supply the voltage |Vs1−Vref| to the conversion element. The supplying of the voltage |Vs1−Vref| is performed at least in a part of the period from time t1 to time t3. Furthermore, the control unit 106 controls the power supply unit 107 such that the power supply unit 107 supplies the voltage |Vs2−Vref| to the conversion element in a period from time t2 at which the characteristic of the conversion element has been stabilized to time t3 at which the image pickup operation is started. In the present embodiment, the supplying of the voltage |Vs2−Vref| to the conversion element is started at time t2. Alternatively, the control unit 106 may monitor whether the characteristic of the conversion element of the detection unit 101 has come into the stable state (that is, whether the conversion element has reached steady-state photoconductivity), and if it is determined that the stable state has been reached, then the control unit 106 may control the power supply unit 107 to start supplying the voltage |Vs2−Vref| to the conversion element at a time when the conversion element has reached steady-state photoconductivity. A monitor/determination unit for performing the above-described process may be disposed in the control unit 106 or in the control computer 108. More specifically, the monitoring and determining whether the stable state has been reached may be performed, for example, as follows. In the preparatory operation for image pickup operation shown in FIG. 4B, the control signals SH and CLK are applied to the reading circuit 103 in a similar manner to the image pickup operation shown in FIG. 4C and the image data output from the reading circuit 104 is monitored, and the image data is compared with a predetermined threshold value to make the determination as to whether the stable state has been reached. In this method, to make it easier to perform the monitoring, a multiplexer may be used to simultaneously output signals from a plurality of columns and/or the gain of the operational amplifier 203 or the variable gain amplifier 206 may be increased to increase the magnitude of the signal obtained from the detector 104. To increase the accuracy of the monitoring, the initialization period and the accumulation operation period in the preparatory operation for image pickup operation may be set to be shorter than the initialization period and the accumulation operation period in the image pickup operation. This makes it possible to reduce the data image acquisition period in the preparatory operation for image pickup operation and thus it is possible to reduce the determination period. Alternatively, the voltage |Vs1−Vref| supplied to the conversion element and the time taken to reach the stable state may be measured, and information indicating the voltage and the stable state reach time may be stored in advance in the storage unit 115. The determination unit may determine whether the stable state has been reached, based on the voltage |Vs1−Vref| supplied to the conversion element in the preparatory operation for image pickup operation and the information stored in the storage unit. More specifically, the time elapsed since the start of the supplying of the voltage |Vs1−Vref| to the conversion element is compared with the stabilization completion time at a particular temperature stored in the storage unit 115. If the elapsed time exceeds the stabilization completion time, it is determined that the stable state has been reached. In the above method, the stabilization completion time may be determined by measuring, using a time or the like, the time taken by the image data to decrease below a predetermined threshold value. The measurement of the time may be performed based on the control signal applied to perform the operation of obtain the image data. The storage unit may be disposed in the control unit 106 or the control computer 108. This is not limited to the present embodiment but may be applied to other embodiments of the present invention.

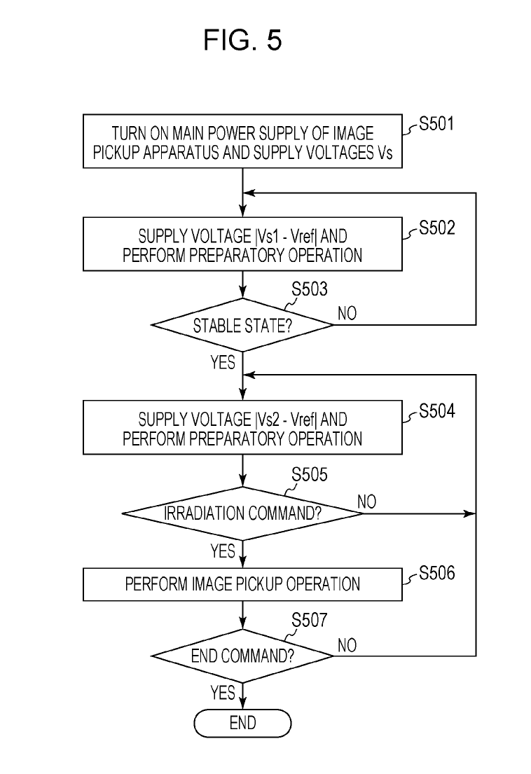

Next, referring to FIG. 5, an operation flow of the image pickup system according to the present embodiment is described below. If a main power supply of the image pickup system is turned on in step S501, then, under the control of the control computer 108, the control unit 106 controls the power supply unit 107 to supply a voltage Vs to the detection unit 101. In step S502, the control unit 106 controls the power supply unit 107 to supply the voltage |Vs1−Vref| (first voltage level) to the conversion element and controls the detector 104 to perform a preparatory operation. In step S503, after a predetermined time has elapsed, a determination is performed as to whether the conversion element of the detection unit 101 has come into the stable state (e.g., it is determined whether the conversion element has reached steady-state photoconductivity). If it is determined that the stable state has not been reached, the preparatory operation for image pickup operation is continued while applying the voltage |Vs1−Vref| to the conversion element. On the other hand, in a case where it is determined that the stable state has been reached, the process proceeds to step S504 in which the control unit 106 controls the power supply unit 107 to supply the voltage |Vs2−Vref| (second voltage level lower than the first voltage level) to the conversion element and controls the detector 104 to perform the preparatory operation for image pickup operation.

In step S505, it is determined whether a radiation exposure command is issued. If the answer to step S505 is NO, the process returns to step S504 in which the control unit 106 controls the power supply unit 107 and the detector 104 such that the preparatory operation for image pickup operation is continued while maintaining the state in which the voltage |Vs2−Vref| is supplied to the conversion element. However, if a radiation exposure command is issued in step S505 (i.e., the answer to step S505 is YES), then the process proceeds to step S506. In step S506, the control unit 106 controls the power supply unit 107 and the detector 104 such that the detector 104 performs the image pickup operation in a state in which the voltage |Vs2−Vref| is supplied to the conversion element. If the image pickup operation is complete and an END command is issued in step S507 (i.e., if the answer to step S507 is YES), then the control unit 106 controls the various units to end the sequence of the operation. If the END command is not issued (i.e., the answer to step S507 is NO), the control unit 106 controls the detector 104 to again perform the preparatory operation for image pickup operation in the state in which the voltage |Vs2−Vref| is supplied to the conversion element.

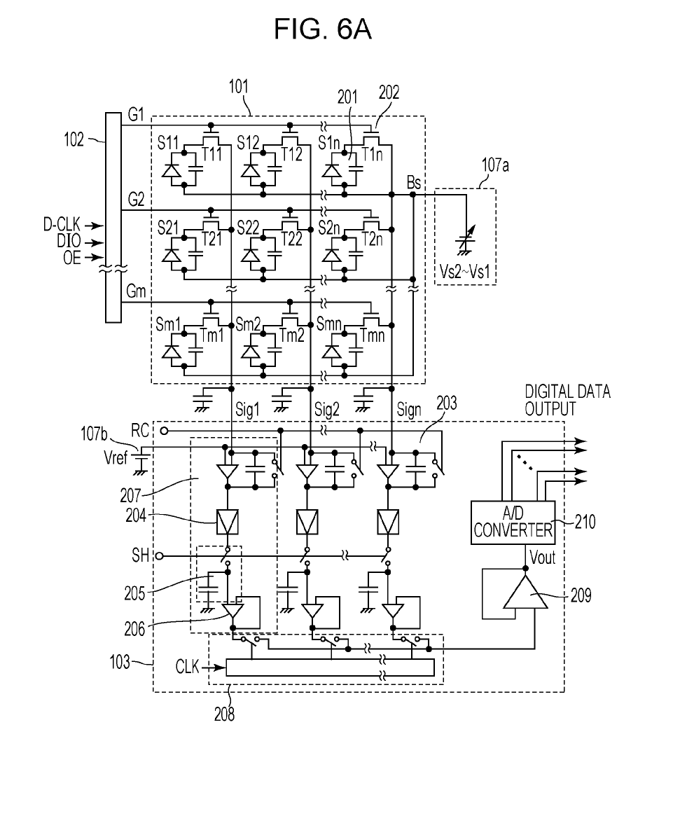

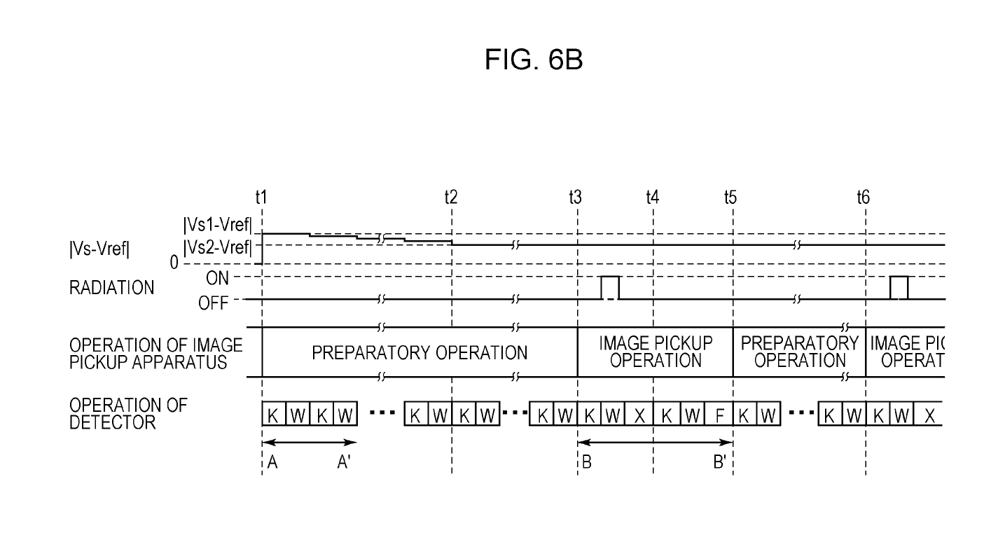

Although in the present embodiment, as described above, the power supply unit 107 includes the bias power supply 107a configured to switch the supply voltage between Vs1 and Vs2, the power supply unit 107 may be configured in another manner. For example, as shown in FIG. 6A, the bias power supply 107a may include a variable power supply capable of outputting a plurality of voltages in a range from Vs1 to Vs2 whereby as shown in FIG. 6B the level of the supplied voltage is changed in a stepwise manner from Vs1 to Vs2 in a period from time t1 to time t2. Alternatively, the reference power supply 107b may include a variable power supply capable of outputting at least two reference voltages Vref1 and Vref2. In this case, the power supply unit 107 supplies |Vs−Vref1| instead of Vs1−Vref| and |Vs−Vref2| instead of |Vs2−Vref| to the conversion element. Furthermore, the control computer 108 may control the radiation control apparatus 109 and the radiation generating apparatus 110 such that irradiation of the radiation is disabled when the voltage |Vs1−Vref| is being supplied to the conversion element.

### Second Embodiment

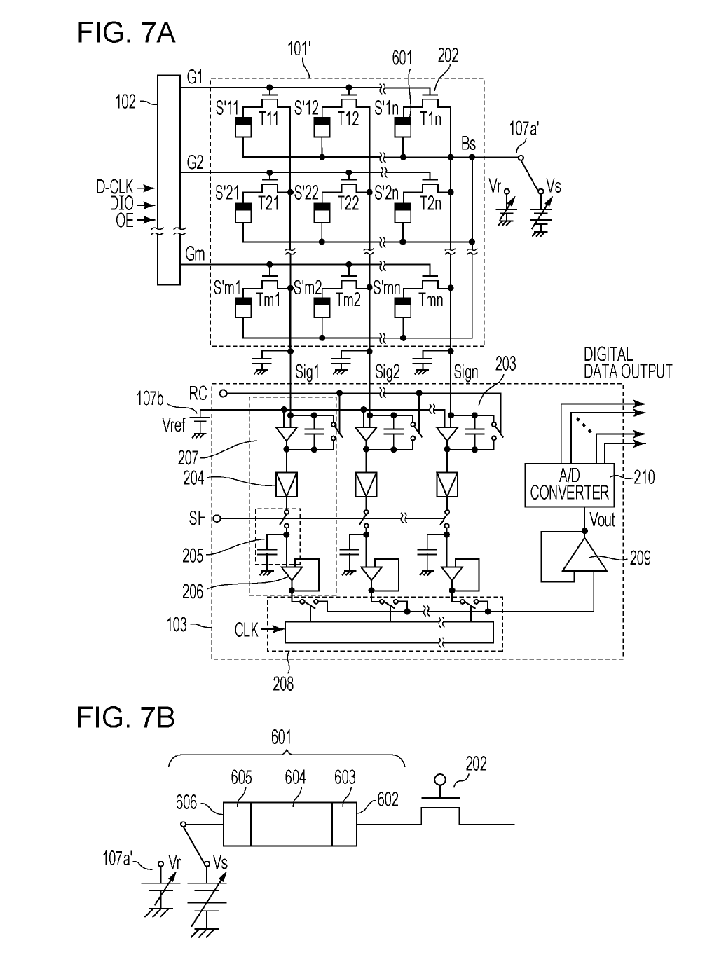

Next, referring to FIGS. 7A and 7B, an image pickup apparatus according to a second embodiment of the present invention is described below. In FIGS. 7A and 7B, similar elements to those shown in FIG. 3 or FIG. 6A are denoted by similar reference symbols or numerals, and a further detailed description thereof is omitted. Although the example shown in FIG. 7A, for simplicity of illustration, the detector of the image pickup apparatus includes pixels arranged in an array with 3 rows and 3 columns as in FIG. 3 or FIG. 6A, practical image pickup apparatuses include a greater number of pixels. FIG. 7B illustrates a simplified equivalent circuit of one pixel.

In the first embodiment described above, each conversion element 201 of the detection unit 101 is realized using a PIN-type photodiode. In contrast, in this second embodiment, each conversion element 601 of a detection unit 101′ is of a MIS-type conversion element realized using a MIS-type photoelectric conversion element. Furthermore, unlike the first embodiment in which the other electrode of each conversion element 201 is electrically connected to the bias power supply 107a via the common bias supply line Bs, the other electrode of each conversion element 601 in the present embodiment is electrically connected to a bias power supply 107a′ via the common bias supply line Bs. This bias power supply 107a′ is configured to also supply a voltage Vr to the other electrode of each conversion element 601 to refresh the conversion elements 601 as well as a voltage Vs. In the present embodiment, the bias power supply 107a′ is configured to supply the voltage Vr to the conversion element 601 to refresh it such that the voltage Vr can be switched at least between two values Vr1 and Vr2.

Furthermore, as shown in FIG. 7B, each conversion element 601 is configured such that a semiconductor layer 604 is disposed between a first electrode 602 and a second electrode 606, and an insulating layer 603 is disposed between the first electrode 602 and the semiconductor layer 604. Furthermore, an impurity semiconductor layer 605 is disposed between the semiconductor layer 604 and the second electrode 606. The second electrode 606 is electrically connected to the bias power supply 107a′ via the bias supply line Bs. As with the conversion element 201, the conversion element 601 is supplied with voltages such that the voltage Vs is supplied to the second electrode 606 from the bias power supply 107a′ and the reference voltage Vref is supplied to the first electrode 602 via the switch element 602 whereby the accumulation operation is performed. In the refreshing process, the refreshing voltage Vr is supplied to the second electrode 606 from the bias power supply 107a′ such that the conversion element 601 is refreshed by the voltage |Vr−Vref|. The refreshing process is performed to eliminate, by moving toward the second electrode 606, electrons or holes of electron-hole pairs that are generated in the semiconductor layer 604 of the MIS-type conversion element and accumulated between the semiconductor layer 604 and the insulating layer 603 without being capable of passing through the impurity semiconductor layer 605. The refreshing process will be described in further detail later.

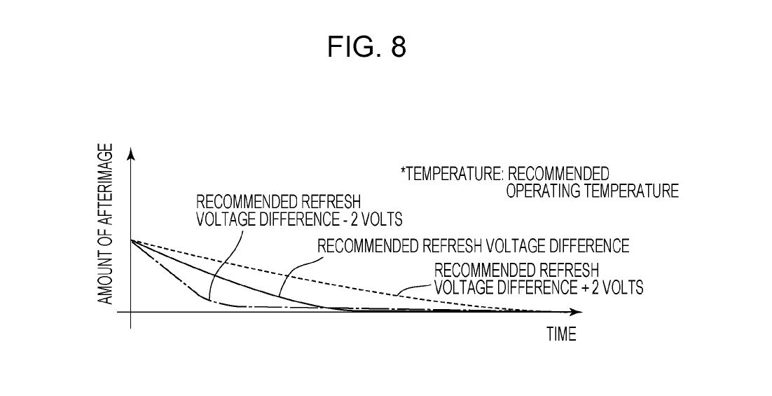

Next, referring to FIG. 8, time-dependent amount of afterimage of the conversion element according to the second embodiment of the present invention is described below. Note that the conversion element has a time-dependent dark current similar to that described above with reference to FIG. 4A, and thus a further detailed description thereof is omitted.

As shown in FIG. 8, an afterimage appears immediately after the voltage is applied to the conversion element. The magnitude thereof is the greatest immediately after the voltage is applied to the conversion element and decreases with elapsed time until it converges to a particular value. This occurs because of following factors specific to the MIS-type conversion element, in addition to similar factors to those described above in the first embodiment. That is, in the MIS-type conversion element, if electron-hole pairs are generated by a dark current or the like, either electrons or holes are accumulated between the semiconductor layer 604 and the insulating layer 603. This can cause the potential Va at the interface between the semiconductor layer 604 and the insulating layer 603 to change with time after the voltage is applied to the conversion element. The change in the potential Va causes the voltage applied to the semiconductor layer 604 to change, and thus, in the MIS-type conversion element, the sensitivity changes with time after the voltage is supplied to the conversion element. Hereinafter, this phenomenon will be referred to as the change in sensitivity. If the image pickup operation is performed in a state in which the sensitivity is changing, then, in the MIS-type conversion elements of the pixels exposed to radiation or light, either electrons or holes of the electron-hole pairs generated by the radiation or light are accumulated between the semiconductor layer 604 and the insulating layer 603, which results in a great change in potential Va. On the other hand, in MIS-type conversion elements of pixels that are not exposed to radiation or light, the potential Va does not have a change caused by electron-hole pairs generated by radiation or light. As a result, the MIS-type conversion elements have a difference in sensitivity between the pixels that are exposed to radiation or light and those that are not exposed. This difference in sensitivity causes an afterimage to appear in image data obtained by a next image pickup operation. The afterimage is great in particular when the refreshing does not eliminate sufficiently either electrons or holes of electron-hole pairs accumulated between the semiconductor layer 604 and the insulating layer 603.

When a sufficiently long time has elapsed and either electrons or holes of the electron-hole pairs generated by the dark current or the like have been accumulated sufficiently between the semiconductor layer 604 and the insulating layer 603, the potential Va converges to a desired potential depending on an elapsed time since the start of the supplying of the voltage to the conversion element. This phenomenon is prominent in particular when the refreshing does not eliminate sufficiently either electrons or holes of electron-hole pairs accumulated between the semiconductor layer 604 and the insulating layer 603. The convergence of the potential Va leads to a reduction in sensitivity difference in the image pickup operation, and the change in sensitivity also converges. Thus, the sensitivity of the conversion element settles to a stable value. This state is referred to as a stable state. In the stable state, the change in potential Va caused by irradiation of light or radiation is also suppressed by the refreshing process. That is, the change in sensitivity of the conversion element caused by irradiation of light or radiation is suppressed, and the amount of afterimage caused the change in sensitivity is reduced. As shown in FIG. 7, an afterimage appears immediately after the voltage is applied to the conversion element. The magnitude thereof is the greatest immediately after the voltage is applied to the conversion element the magnitude thereof is the greatest immediately after the voltage is applied to the conversion element and decreases with elapsed time toward a particular convergence value in the stable state.

The investigation performed by the present inventors has also revealed the followings. As shown in FIG. 8, as the voltage applied to the semiconductor layer of the conversion element increases, the time needed for the amount of afterimage caused by the change in sensitivity to converge to a particular value decreases. This is because as the voltage applied to the semiconductor layer of the conversion element increases, the dark current increases and the number of electron-hole pairs generated thereby increases. As a result, the number of either electrons or holes of electron-hole pairs accumulated between the semiconductor layer 604 and the insulating layer 603 increases, and the potential Va converges to a desired potential in a shorter time.

In the MIS-type conversion element, the voltage V1 applied to the semiconductor layer of the conversion element is given by a following formula.

Vi=|Vs−(Vr−Vref)*Ci/(Ci+cn)|

where Ci is the capacitance of the semiconductor layer 604, and Cn is the capacitance of the insulating layer 603. Thus, as can be seen, in the MIS-type conversion element, in addition to the factors discussed in the first embodiment, the above-described change in characteristic is caused by following factors. That is, as the voltage Vr used in the refresh operation decreases, the voltage V1 applied to the semiconductor layer of the conversion element increases. Therefore, in the MIS-type conversion element, in addition to the effect of the Vs discussed in the first embodiment, the voltage Vr used in the refresh operation affects the change in characteristic such that as the voltage Vr decreases, the time needed for the amount of afterimage caused by the change in sensitivity to converge to a particular value decreases.

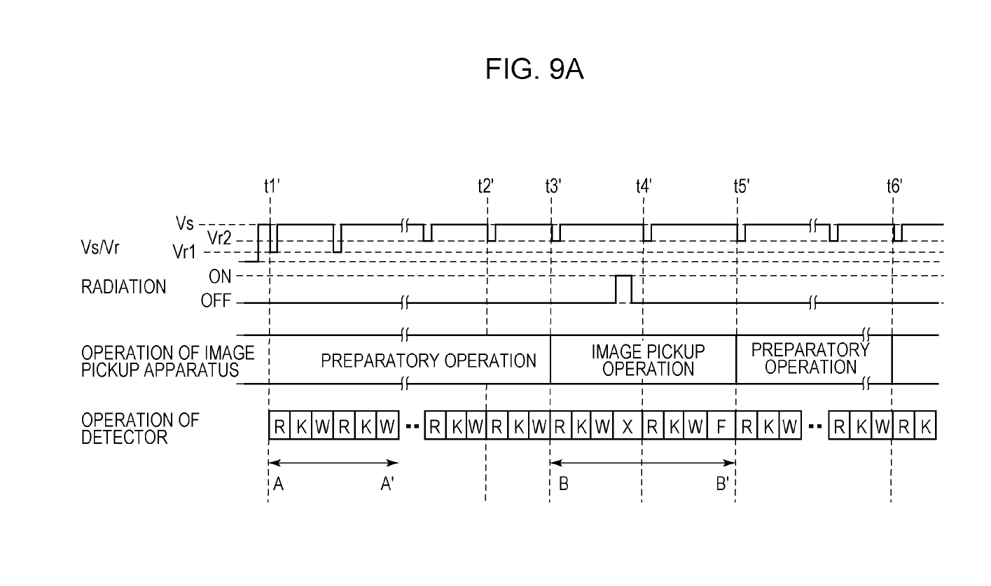

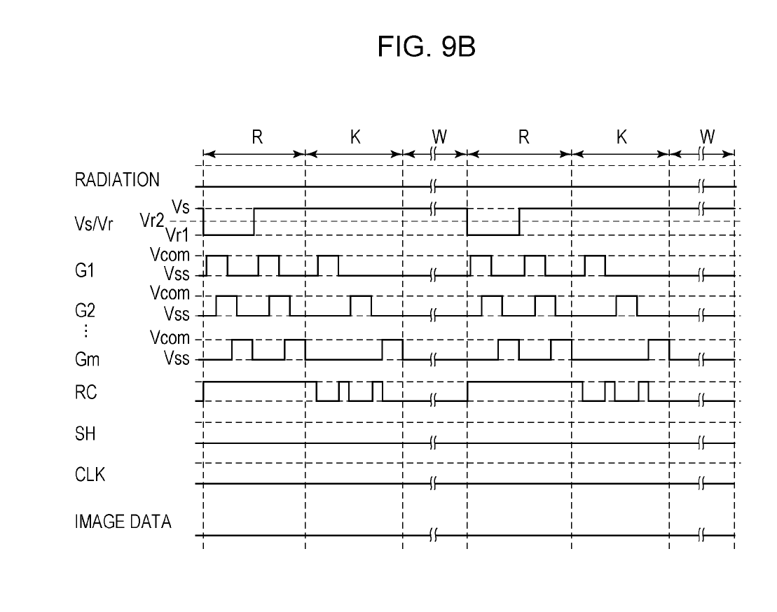

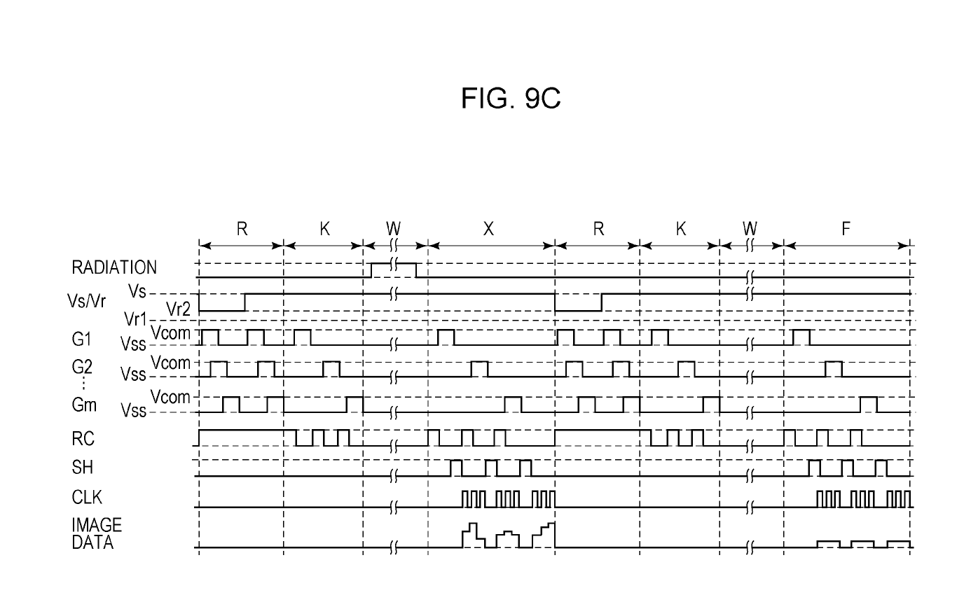

Next, referring to FIGS. 9A to 9C, the operation of the image pickup apparatus according to the present embodiment is described below. FIG. 9A illustrates general driving timing of the image pickup apparatus, FIG. 9B illustrates details of an interval from A to A′ in FIG. 8A, and FIG. 9C illustrates details of an interval from B to B′ in FIG. 9A. In FIGS. 9A to 9C, similar elements to those shown in FIGS. 4A to 4C are denoted by similar reference symbols or numerals, and a further detailed description thereof is omitted. Note that reference symbols with primes indicate similar elements in FIGS. 4A to 4C.

In the first embodiment described above, the preparatory operation for image pickup operation is performed such that a set of operations including the initialization K and the accumulation operation W is performed repeatedly a plurality of times. In contrast, in the present embodiment, the preparatory operation for image pickup operation is performed such that a set of operations includes the refresh operation R, the initialization K and the accumulation operation W, and the set of operations is performed repeatedly a plurality of times. The refreshing process is performed to eliminate, by moving toward the second electrode 606, electrons or holes of electron-hole pairs that are generated in the semiconductor layer 604 of the MIS-type conversion element and accumulated between the semiconductor layer 604 and the insulating layer 603 without being capable of passing through the impurity semiconductor layer 605. In the first embodiment described above, the image pickup operation includes a sequence of the initialization K, the accumulation operation W, the image output operation X, the initialization K, the accumulation operation W, and the dark image output operation F. In the present embodiment, the image pickup operation further includes a refresh operation R performed before each initialization K. In the refresh operation, first, the refreshing voltage Vr is supplied to the second electrode 604 via the bias supply line Bs. Next, the reference voltage Vref is supplied to the first electrode 602 via the switch element whereby the conversion element 601 is refreshed by the bias voltage |Vr−Vref|. A plurality of conversion elements 601 are sequentially refreshed on a row-by-row basis until all conversion elements 601 are refreshed and all switch elements are turned off. Thereafter, the voltage Vs is supplied to the second electrode 606 of the conversion element 601 via the bias supply line Bs and the reference voltage Vref is supplied to the first electrode 602 via the switch elements whereby the bias voltage |Vs−Vref| is supplied to the conversion element 601. When all switch elements are turned into the off-state, all conversion elements 601 are in a bias state that allows the image pickup operation to be performed, and the refresh operation is complete. Next, the initialization K is performed to initialize the conversion element 601 and stabilize the output characteristic. Thereafter, the accumulation operation W is performed.

In the present embodiment, in at least a part of the preparatory operation for image pickup operation period, and more specifically, in a period from time t1′ to time t2′ in the preparatory operation for image pickup operation period from time t1′ to time t3′, the voltage Vr1 for the refresh operation is supplied from the bias power supply 107a′ thereby performing the refresh operation. The voltage Vr1 is set to be lower than the voltage Vr2 used in the refresh operation in the image pickup operation. The characteristic of the conversion element is stabilized by the preparatory operation for image pickup operation performed in this period. If the change in characteristic of the conversion element has been stabilized, then in a period from time t2′ to time t3′, the voltage Vr2 for the refresh operation is supplied from the bias power supply 107a′ thereby performing the refresh operation. In any image pickup operation after time t3′, the voltage Vr2 for the refresh operation is supplied from the bias power supply 107a′ thereby performing the refresh operation in a similar manner.

In the present embodiment, the voltage Vr is used in the refresh operation. Alternatively, as in the first embodiment, Vs1 and Vs2 may be used. Still alternatively, the bias power supply 107a′ may include a variable power supply capable of outputting a plurality of voltages in a range from Vs1 to Vs2 whereby the voltage may be stepwisely changed from Vs1 to Vs2 in the period from time t1′ to time t2′. Still alternatively, the bias power supply 107a′ may include a variable power supply capable of outputting a plurality of voltages in a range from Vr1 to Vr2 whereby the voltage may be stepwisely changed from Vr1 to Vr2 in the period from time t1′ to time t2′. Alternatively, the reference power supply 107b may include a variable power supply capable of outputting at least two reference voltages Vref1 and Vref2.

Thus, as with the first embodiment, the present embodiment provides the small-size, small-weight, and easy-control image pickup apparatus capable of capturing a high-quality image while suppressing a change in characteristics of the image pickup apparatus and also provides the image pickup system using such an image pickup apparatus.

The above-described embodiments of the present invention may also be implemented by executing a program by a computer in the control unit 106 or by the control computer 108. An implementation of any embodiment of the invention using a computer-readable storage medium such as a CD-ROM for supplying the program to the computer also falls within the scope of the present invention. Similarly, an implementation of any embodiment of the invention using a transmission medium such as the Internet to transmit the program also falls within the scope of the present invention. The program described above falls within the scope of the present invention. That is, the above-described program, the storage medium, the transmission medium, and the program product all fall within the scope of the present invention. Furthermore, any combination of the first and second embodiments described above falls within the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-065981 filed Mar. 24, 2011, which is hereby incorporated by reference herein in its entirety.

What is claimed is:

1. An image pickup apparatus comprising:
a detector including a detection unit and a driving circuit, the detection unit including a plurality of conversion elements each including a semiconductor layer configured to convert radiation or light into an electric charge, and the driving circuit being configured to drive the detection unit to output an electric signal corresponding to the electric charge from the detection unit, wherein the detector performs an image pickup operation to output the electric signal;
a power supply unit configured to supply voltage to the conversion elements; and
a control unit configured to control the power supply unit such that the voltage applied to the semiconductor layer during at least part of a period prior to a start of the image pickup operation is higher than the voltage applied to the semiconductor layer in the image pickup operation.

2. The image pickup apparatus according to claim 1, wherein the control unit controls the power supply unit such that the voltage applied to the semiconductor layer is higher in at least part of a period from the start of supplying the voltage to the semiconductor layer from the power supply unit to the start of the image pickup operation than in the image pickup operation.

3. The image pickup apparatus according to claim 1, further comprising a determination unit configured to determine whether the conversion element has come into a stable state.

4. The image pickup apparatus according to claim 3, further comprising a storage unit configured to store information associated with the voltage applied to the conversion element and information associated with a time at which the stable state has been reached,
wherein the determination unit determines whether the conversion element has come into the stable state, based on the voltage applied to the conversion element, the length of time elapsed since the start of supplying the voltage to the detection unit from the power supply unit, and the information stored in the storage unit.

5. The image pickup apparatus according to claim 1, wherein the power supply unit includes a variable power supply capable of outputting a voltage with a stepwise value selected from a plurality of values in a range from the voltage supplied to the conversion element in the image pickup operation to the voltage supplied to the conversion element in at least the part of the period.

6. The image pickup apparatus according to claim 1, wherein the conversion element includes a PIN-type photodiode.

7. The image pickup apparatus according to claim 1, wherein
the conversion element includes a MIS-type photoelectric conversion element,
the power supply unit supplies a voltage to the MIS-type photoelectric conversion element to refresh the MIS-type photoelectric conversion element, and
the voltage supplied to the MIS-type conversion element in at least the part of the period to refresh the MIS-type conversion element is lower than the voltage supplied to the MIS-type conversion element to refresh the MIS-type conversion element in the image pickup operation.

8. An image pickup system comprising:
the image pickup apparatus according to claim 1; and
a control computer that transmits a control signal to the control unit.

9. A method of controlling an image pickup apparatus that includes a detector having a detection unit and a driving circuit, the detection unit including a plurality of conversion elements each including a semiconductor layer configured to convert radiation or light into an electric charge, and the driving circuit being configured to drive the detection unit to output an electric signal corresponding to the electric charge from the detection unit, the method comprising:
performing an image pickup operation to output the electric signal; and
applying a voltage to the semiconductor layer during at least a part of a period prior to a start of the image pickup operation such that the voltage is higher than a voltage applied to the semiconductor layer in the image pickup operation.

10. A method of controlling an image pickup apparatus that includes a detector having a detection unit and a driving circuit, the detection unit including a plurality of conversion elements arranged in a matrix, each conversion element including a semiconductor layer configured to convert radiation or light into an electric charge, and the driving circuit being configured to drive the detection unit to output an electric signal corresponding to the electric charge from the detection unit, the method comprising:
applying voltage at a first voltage level to the semiconductor layer of at least one conversion element;
determining whether the at least one conversion element has reached a stable state;
applying the voltage at a second voltage level lower than the first voltage level to the semiconductor layer of the at least one conversion element, after the at least one conversion element has reached the stable state; and
performing an image pickup operation by controlling the driving circuit to output the electric signal corresponding to the electric charge from the detection unit.
